(19) United States
(12) Patent Application Publication
(10) Pub. No.: US 2007/0234917 A1
(43) Pub. Date: Oct. 11, 2007

(54) REPEAT BUILDER WITH REPLACEABLE OUTER SURFACE FOR PRINTING PRESS

(76) Inventors: Mark C. Davis, Chester, VA (US); Michael A. Smoot, Chesterfield, VA (US); Paul E. Hartsell, Prince George, VA (US); Kenneth A. Odom, Midlothian, VA (US)

Correspondence Address: Connolly Bove Lodge & Hutz, LLP, P.O. Box 2207, Wilmington, DE, 19899-2207, US

(21) Appl. No.: 11/695,217

(22) Filed: Apr. 2, 2007

Related U.S. Application Data
(60) Provisional application No. 60/790,500, filed on Apr. 6, 2006.

(51) Int. Cl. B41F 13/20

(52) U.S. Cl. 101/479

(57) ABSTRACT

A dual use repeat builder assembly comprising a multiply inner sleeve with a bond layer surrounding its outer diameter for securing a compressible foam layer to the outer surface of the inner sleeve. A hard foam core is formed around the compressible foam layer using a mold cavity. After curing, the mold is removed and the ends of the hard foam core are machined creating cavity regions at each end. A notch insert is positioned at one or both of the cavity ends. A polymeric resin is poured into the cavities to form end caps. The outer surface of the hard foam and the end caps is machined to produce a smooth surface. An outer sleeve is mounted onto the hard foam core using compressed air with a resulting interference fit between the outer sleeve and the hard foam layer. Location of the end caps are such that holes can later be drilled through the wall thickness to convert the repeat builder to a bridge mandrel to enable mounting of thin sleeves to its outer surface. After extended use and wear, the outer sleeve can be removed by expanding it with air and replacing it with a new outer sleeve thus extending the useful life of the unit and/or modifying its outer diameter.

### CROSS REFERENCE TO RELATED APPLICATION

This application is based on provisional application Ser. No. 60/790,500, filed Apr. 6, 2006.

### BACKGROUND OF THE INVENTION

Repeat builders have been used for more than twenty years in the printing industry to reduce costs, improve job efficiency and increase productivity. Repeat builders are used to increase cylinder diameters, thus achieving larger print diameters, also known as “repeats”. Repeat builders are also used to keep printing plates mounted to avoid having to de-mount or re-mount plates each time a job is run, thereby saving both time and money.

A number of approaches have been described in the art for increasing print repeats and/or keeping plates mounted on sleeves. Reference is made to U.S. Pat. Nos. 3,978,254, 4,030,415, 4,601,928, 4,903,597, 5,215,013, 5,256,459, 5,301,610, 5,425,693 and 6,401,613 which exemplify known approaches. All of the details of these patents are incorporated herein by reference thereto.

Typically, sleeves in excess of 0.250″ thick are used as repeat builders and not as often for keeping plates mounted due to their high inherent cost. While these sleeves have served the purpose of increasing repeat diameters, they have not held up well under the rigors of the printing environment. Sleeves are often chipped and cracked due to the brittle nature of the materials used. Further, these sleeves typically have a metal insert with a machined notch in order to position the sleeve on the mandrel via a registration pin. These metal inserts frequently become loose and in a worse case scenario, fall out of the sleeve, thus running the risk of damaging the printing plates, anilox rolls, print cylinders, or central impression cylinders. In addition, repeat builders with hard foam layers exposed to the atmosphere have been known to swell due to moisture and solvents becoming absorbed into the foam cells. Also, the labor intensive, one-at-a-time manufacturing approach used in making these sleeves results in long lead times for the printer. Finally, knife cuts on the sleeve surface can result in an unacceptable level of damage making the sleeve unusable over time.

### SUMMARY OF THE INVENTION

An object of this invention is to provide an improved repeat builder which overcomes various disadvantages of the prior art.

A further object of this invention is to provide a repeat builder that would be more durable, exhibit a secure notch and pin, have a readily replaceable outer surface, and provide an extended service life.

In accordance with this invention the repeat builder is comprised of a cylindrical inner sleeve. A compressible foam layer is bonded to the inner sleeve using an adhesive film. An expanding foam material is poured around the compressible foam layer and contained by a larger cylindrical mold with end plates which define the outer diameter of the poured foam layer or core. Once the poured foam material has fully expanded and cured, the foam becomes hard and rigid. The mold and end plates are removed and the base is post cured in an oven. The ends of the hard foam core are faced to a specified length with a step machined into each end of the hard foam, approximately ¾″ long. A U-shaped notch is machined into one end of the inner sleeve thus producing an open slot at one end of the unit. Notches can be placed at both ends if desired. Flexible sheet stock is wrapped around each end of the unit and taped to the hard foam core to form a cavity within the hard foam approximately 1″ long. An insert is placed within the notch that was machined in the inner sleeve located within the cavity(s). The insert has a notch that will match the registration pin the unit will eventually mount to. It is designed to withstand the repeated impact with the registration pin experienced each time the unit is mounted onto a cylinder or mandrel. The cavities are filled with a suitable polymeric resin for sealing the ends of the hard foam core and fully encapsulating the notch insert. After curing, the sheet stock is removed and the end caps are now formed. The outer diameter of the unit is machined to a specific size. Means for providing air to the outer diameter of the end cap opposite the end with the notch is achieved through a small hole in the face and an air channel around the circumference of the end cap at a location approximately ½″ from the end. An outer sleeve is then mounted onto the hard foam core using compressed air introduced through the hole in the end cap and distributed along the air channel to expand the outer sleeve. The outer sleeve has an interference fit with the hard foam core, thus causing the outer sleeve to remain locked in position over the hard foam core. Once the assembly is complete, the unit is faced to the desired length and ground to the desired diameter. When after extensive use the sleeve surface becomes marred due to damage from knife cuts or impact with other components, the outer sleeve can be removed via air expansion and a new outer sleeve can be applied. Further, it is possible to use a new sleeve with a different thickness, thus expanding the usefulness of the refurbished sleeves to a new repeat size. Finally, the thick sleeve can be converted to a bridge mandrel at a later date due to the location of the end caps by drilling holes through the thickness.

### THE DRAWINGS

FIG. 1 is an overall view of the repeat builder in accordance with this invention;

FIG. 2 is a cross-sectional view down the length of the repeat builder, thus exposing the internal elements in accordance with this invention;

FIG. 3 is an expanded cross section of the portion shown in dashed lines in FIG. 2 of the repeat builder, thus exposing the individual components within the main body of the repeat builder in accordance with this invention;

FIG. 4 is a side view of one end cap after machining with a u-shaped notch machined in the end; in accordance with this invention;

FIG. 5 is a side view of the machined end cap with an insert in place and prepared for pouring the end cap in accordance with this invention;

FIG. 6A is an isometric view of a straight notch insert in accordance with this invention;

FIG. 6B is an isometric view of a straight notch insert rotated 90⁰ to show the multiple surfaces available for mechanical and adhesive fastening to the end cap in accordance with this invention;

FIG. 6C is an isometric view of a bayonet notch insert in accordance with this invention;

FIG. 7A is a cross section of an end cap ready to receive the outer sleeve in accordance with this invention;

FIG. 7B is a cross section of an end cap after it has received the outer sleeve in accordance with this invention;

FIG. 8A is an end view of a thick sleeve without a notch insert in accordance with this invention;

FIG. 5B is an end view of a thick sleeve with a notch insert in accordance with this invention;

FIG. 5C is a cross-sectional view of a thick sleeve revealing the notch insert in accordance with this invention;

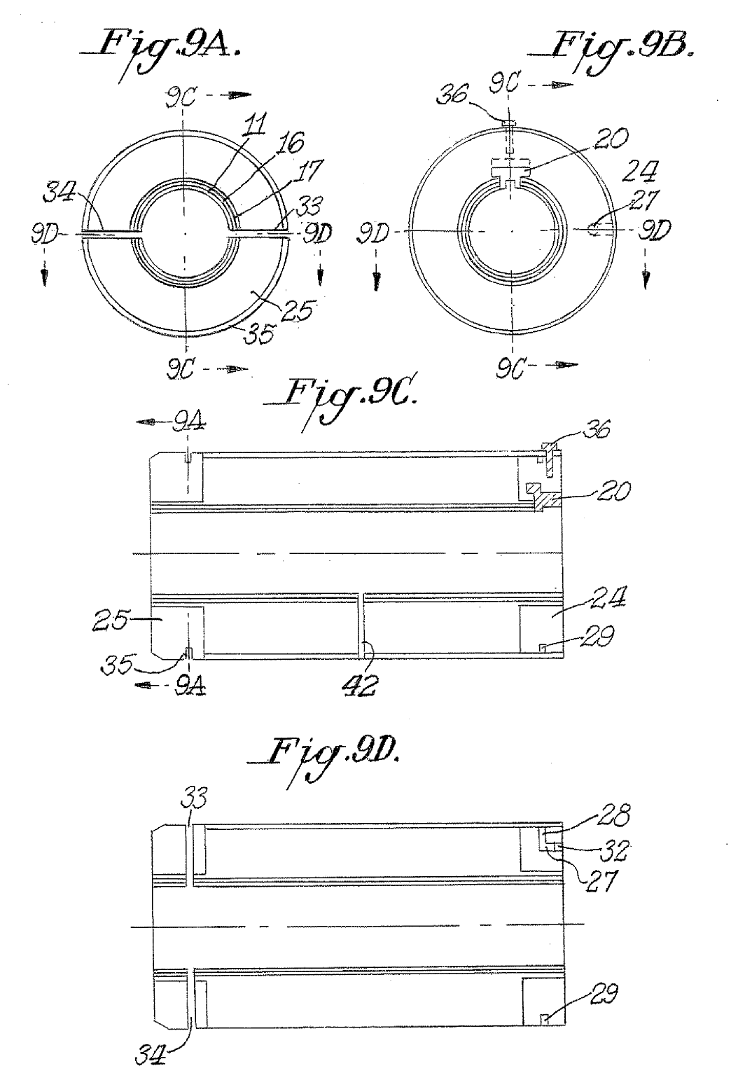

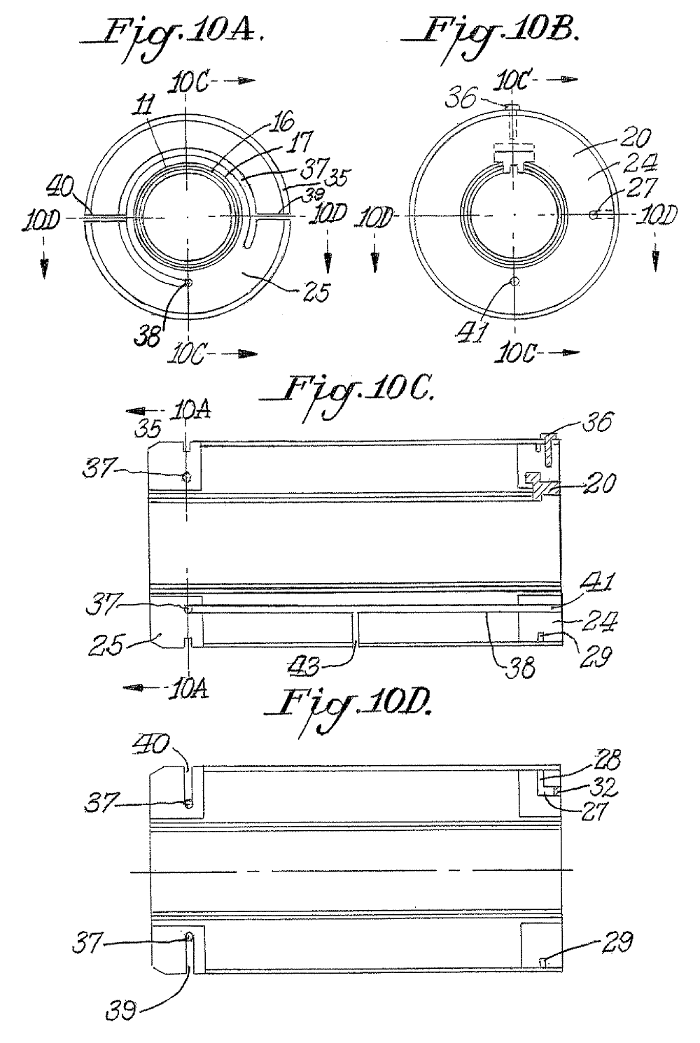

FIG. 8D is a cross-sectional view of a thick sleeve revealing the air holes for mounting the outer sleeve in accordance with this invention;

FIG. 9A is a cross section of a bridge mandrel end cap thus exposing the thru-holes in accordance with this invention;

FIG. 9B is an end view of a bridge mandrel with a notch insert and registration pin in accordance with this invention;

FIG. 9C is a cross-sectional view of a bridge mandrel revealing the notch insert, registration pin and a downstream hole in accordance with this invention;

FIG. 9D is a cross-sectional view of a bridge mandrel revealing the air holes for mounting the outer sleeve and thru-holes for mounting plate sleeves in accordance with this invention;

FIG. 10A is a cross section of a bridge mandrel end cap thus exposing the air distribution ring in accordance with this invention;

FIG. 10B is an end view of a bridge mandrel with a notch insert and registration pin in accordance with this invention;

FIG. 10C is a cross-sectional view of a bridge mandrel revealing the notch insert, registration pin, internal piping and downstream hole in accordance with this invention; and

FIG. 10D is a cross-sectional view of a bridge mandrel revealing the air holes for mounting the outer sleeve and the air holes for mounting plate sleeves in accordance with this invention;

### DETAILED DESCRIPTION

The present invention relates to improvements in a repeat builder which would be mounted to a fixed mandrel or print cylinder while operating in a Flexographic or Rotogravure printing press. In general, the repeat builder of this invention consists of an expandable inner sleeve; a compressible foam layer secured to the outer circumference of the inner sleeve by means of an adhesive bond layer; a generally hard (non-compressible) foam layer or core surrounding the compressible foam; solid, non-porous polymeric end caps; a registration notch embedded in the end cap which is both mechanically and adhesively secured; and an outer sleeve having an inner diameter smaller than the outer diameter of the hard foam core thus producing an interference fit and securing the outer sleeve in place.

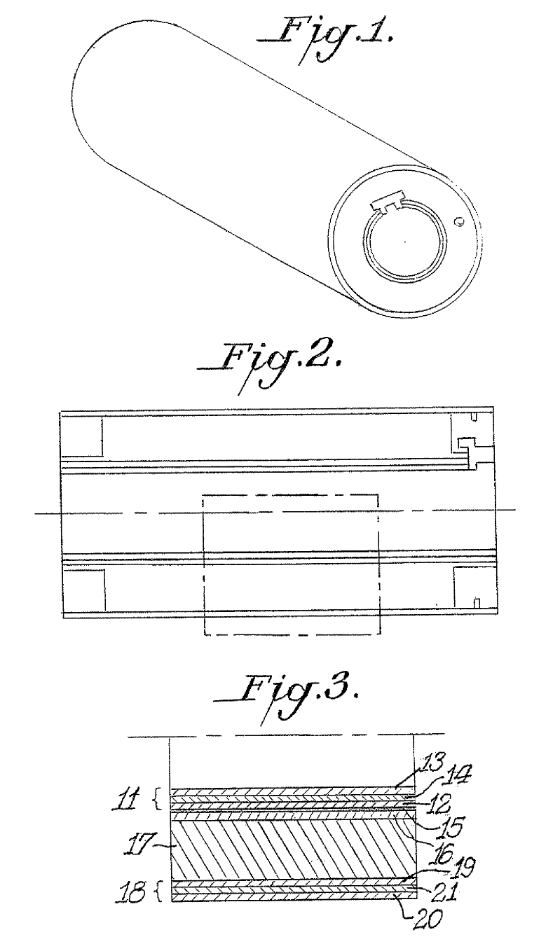

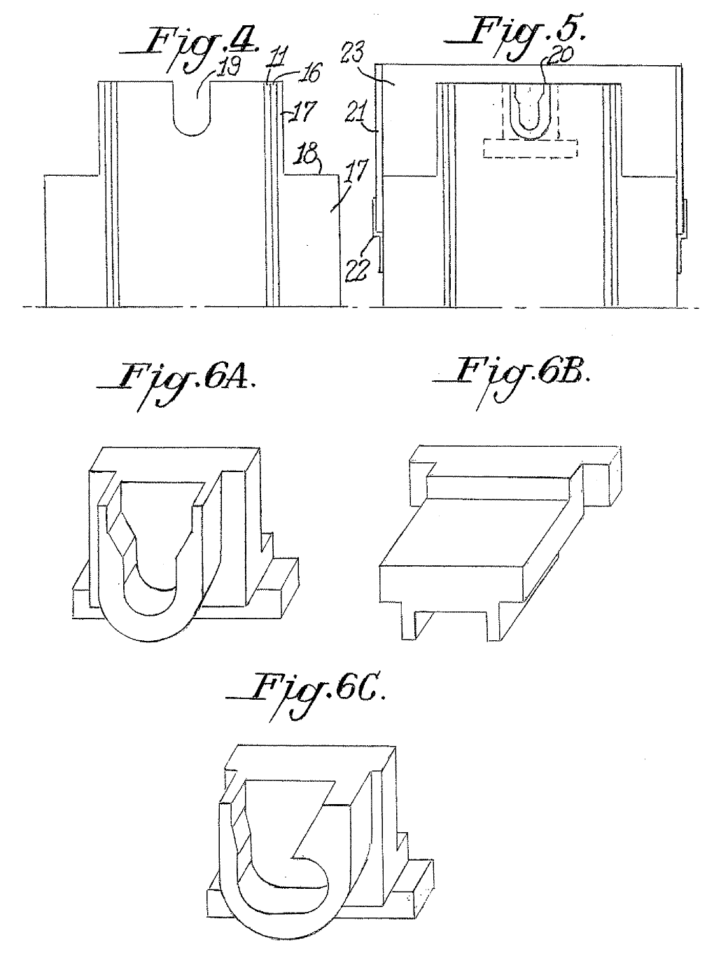

FIG. 1 shows the general shape of the repeat builder 10. FIG. 2 shows the repeat builder 10 if it were sliced down the length, thus exposing the internals elements. FIG. 3 shows an expanded cross section of the repeat builder thus exposing the individual components within the repeat builder itself; excluding the end caps. An inner sleeve 1 consists of two or more layers of film 12 and 13 joined by hot-melt adhesive 14 resulting in a laminate which is cylindrical in shape in order to fit securely to a fixed mandrel or print cylinder. The inner diameter of the inner sleeve 11 is smaller than the mandrel or cylinder the repeat builder will ultimately be mounted to in order to provide an interference fit and hold the repeat builder securely in place. In the preferred embodiment the inner sleeve 11 is a spiral wound sleeve made of polyester film and polyethylene hot-melt adhesive.

An adhesive bond layer 15 is applied to the outside of the inner sleeve 11 in order to secure a compressible foam layer 16 to the exterior of the inner sleeve 11. Suitable materials for the bond layer 15 include epoxy adhesive or pressure sensitive tape. The compressible foam layer 16 allows the inner sleeve 11 to readily expand when the repeat builder is mounted to a mandrel or print cylinder using air pressure supplied to the mandrel. Suitable materials for the compressive foam include urethane or silicone rubber foam products having a density between ten and thirty-five pounds per cubic foot.

A hard foam core 17 is applied to the surface of the compressible foam layer 16. This is accomplished by either pouring or injecting a multi-component foam liquid such as polyurethane into a cavity formed by the compressible foam layer 16 and a larger cylindrical mold with end plates which define the outer diameter of the hard foam layer 17. After cure, the polyurethane becomes a hard foam core 17. The hard foam core 17 is the primary means for adjusting the desired repeat builder thickness which can range from 0.25″ to 3.00″ thick. Consequently, the thickness of the hard foam core 17 will vary depending upon the required thickness of the repeat builder. The hard foam core material should be chosen so that the resulting density is between ten and twenty-five pounds per cubic foot. The actual density will depend upon the load levels experienced by the repeat builder when running on a press because density is related to compressive strength.

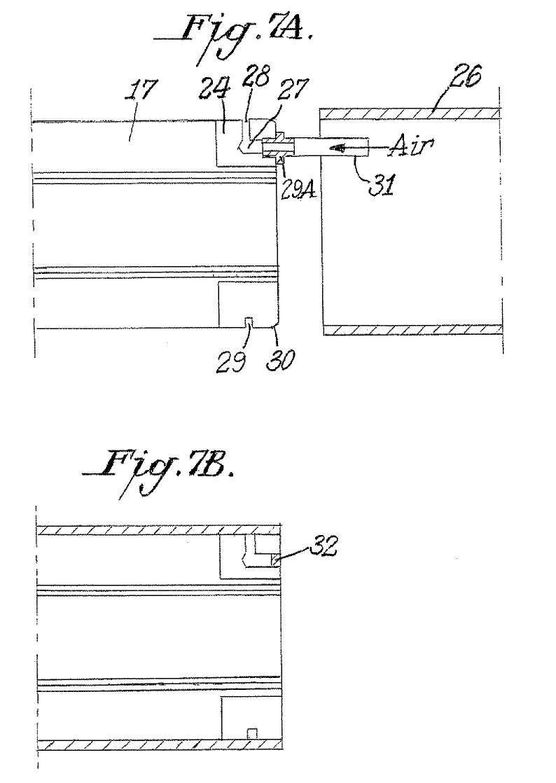

Once the hard foam core has solidified, the unit is post cured in an oven. After post cure, the unit is machined on the ends to produce a step in the hard foam core to aid in forming the solid urethane end caps. FIG. 4 shows one end of the unit after machining and indicates the step 18 created during the machining process. From this figure it is evident that a thin layer of hard foam 17 remains over the compressible foam 16 and inner sleeve 11. If the repeat builder will be mounted to a mandrel having a registration pin, then a notch 19 is cut into the inner sleeve/compressible foam/hard foam core to allow positioning of an insert in the cavity region. FIG. 5 shows an insert 20 in position within the notch 19.

Sheet stock 21 is then wrapped around each end of the hard foam core 17 and secured to the core with tape 22 to create a cavity 23 approximately 1″ long between the sheet material 21 and the step 18 in the hard foam core. A liquid polymeric material such as urethane elastomer is then poured into the cavity 23 and allowed to cure. After the polymeric material has cured, the sheet stock 21 and tape 22 are removed to reveal the formed end cap.

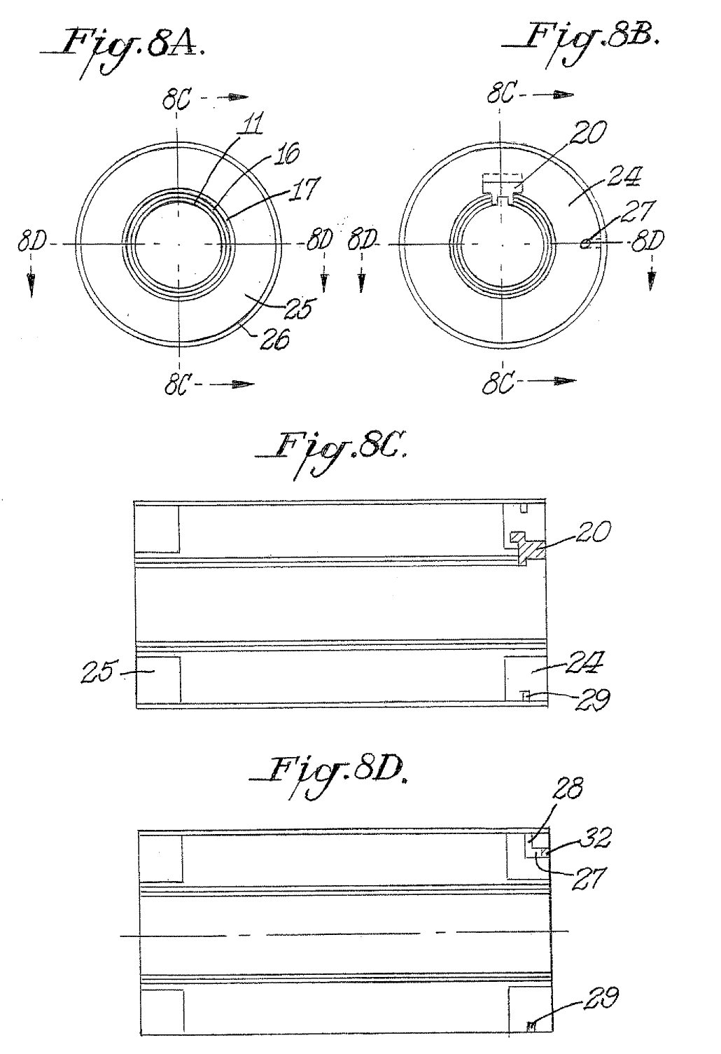

The insert 20 is designed to provide multiple points of contact with the cured urethane elastomer so the insert 20 cannot be dislodged from the repeat builder due to repeated impact loads with the registration pin. Examples of two inserts are shown in FIG. 6. FIG. 6A shows an insert with a straight notch design for receiving the registrations pin. FIG. 6B shows the same insert viewed from above to clearly reveal the multiple surfaces available for mechanically and adhesively securing the insert into the poured urethane end cap. This protects the insert from being dislodged due to axial, radial or transverse loads when mounting or demounting the repeat builder on the press. FIG. 6C shows an insert with a bayonet notch design. This design enables a repeat builder designed to serve as a bridge mandrel to be locked in place on a mandrel so outer sleeves can be mounted or demounted to the bridge mandrel.

FIG. 7A shows a cross section of an end cap 24 after removal of the sheet stock and tape. The end cap with the insert 20 will be referred to as end cap 24 whereas the end cap at the other end of the unit will be referred to as end cap 25. End cap 24 is shown having been modified to enable mounting of the outer sleeve 26. This is accomplished by drilling and tapping a horizontal inlet hole 27 (˜¼″ diameter) into the face of the end cap 24 to a depth of ¾″. A hole 28 (˜⅛″ diameter) is drilled radially from the outer diameter of the end cap 24 at a location approximately ¾″ from the edge of the end cap 24 to a depth that allows it to connect to the inlet hole 27 in the end cap 24. An air channel 29 (˜ 1/16″ wide×˜ 1/16″ deep) is then machined around the circumference of the end cap 24, coincident with the radial hole 28. A chamfer 30 (˜10 degrees by ⅛″ wide) is then machined at the edge of the end cap 24 to assist with mounting the outer sleeve 26.

An outer sleeve 26 is mounted over the end cap 24 and hard foam core 17, hereafter referred to only as the hard foam 17. The outer sleeve 26 is secured to the hard foam 17 by means of an interference fit. This is achieved by having the outer diameter of the hard foam 17 larger than the inner diameter of the outer sleeve 26. The interference range is from 0.05% to 0.30% of the repeat builder diameter. The level of interference will depend upon the elastic modulus (stiffness) of the outer sleeve. For high modulus materials such as fiberglass or carbon fiber thermoset composites the interference level will be relatively low whereas for low modulus materials such as non-reinforced thermoplastic composites the interference level will be relatively high. Mounting the outer sleeve 26 onto the hard foam 17 is accomplished by providing pressurized air to the outer diameter of the repeat builder core. This is achieved by attaching an air fitting 29A to the inlet hole 27 and supplying pressurized air through a hose or tube 31. As the outer sleeve 26 is pushed over the end cap 24 and covers the air channel 29, the pressurized air distributes within the air channel 29 thus supplying air to the full circumference of the end cap 24. The pressurized air causes the outer sleeve 26 to expand and create an air bearing between the outer sleeve 26 and the hard foam 17 surface. Once the flow of pressurized air is discontinued, the outer sleeve 26 will remain secure to the hard foam 17 and end caps 24 and 25 due to the interference fit that exists between these surfaces. Once mounted, the end caps 24 and 25 are machined to length and a plug 32 is screwed into the threaded inlet hole 27 to prevent moisture from entering the unit. FIG. 7B shows an end of the repeat builder after the outer sleeve 26 has been mounted over the hard foam 17 and end cap 24. If during the life of the repeat builder the outer sleeve becomes damaged or a change in diameter is required, the outer sleeve 26 can be replaced by removing the plug 32 and pressurizing with air in the same manner the outer sleeve 26 was originally mounted. A new outer sleeve can be mounted, the outer diameter machined to the appropriate size, and the unit can be returned to service.

FIGS. 8A, 8B, 8C and 8D show various views of a complete repeat builder for use as a thick sleeve. FIG. 8A shows an end view of a thick sleeve exhibiting the inner sleeve 11, compressible foam layer 16, thin layer of hard foam 17, end cap 25 and outer sleeve 26 FIG. 8B shows the opposite end of the thick sleeve exhibiting the end cap 24, insert 20 and inlet hole 27. The lines 8C-8C and 8D-8D in FIGS. 8A and 8B depict where cross sections are taken to expose internal components in FIGS. 8C and 8D.

FIG. 8C shows a cross section of the thick sleeve taken at the section line 8C-8C defined on FIGS. 8A and 8B. This figure exposes the components from the previous two drawings but also shows the air channel 29 that runs the full circumference of end cap 24. This is the air channel used to mount the outer sleeve to the thick sleeve as previously described. FIG. 8D shows a cross section of the thick sleeve taken at the section lines 8D-8D defined in FIGS. 8A and 8B. This figure exposes the components from the previous three drawings but also the radial hole 28 that connects the inlet hole 27 to the air channel 29. The plug 32 is also shown threaded into inlet hole 27.

The repeat builder of this invention can also be used as bridge mandrel. A bridge mandrel is used in conjunction with sleeves to mount printing plates onto lower cost, thinner sleeves while achieving the larger print diameter (also know as “repeat”) primarily through the thickness of the bridge mandrel. Air pressure is used to mount sleeves onto bridge mandrels in a manner similar to what was described earlier when mounting the outer sleeve over a thick sleeve. The main difference is that the plate sleeves will typically be mounted and de-mounted from the bridge mandrel with every print job that is run. The air pressure to mount the plate sleeves onto the bridges is typically delivered through either 1) a pressurized mandrel that the bridge is mounted to, 2) a mounting unit that seals the ends of the bridge and fills the inside with pressurized air, or 3) air supplied directly to the bridge mandrel which is distributed through the bridge mandrel body using a series of interconnected pipes or tubes. Methods 1) and 3) are the most common means for mounting plate sleeves to bridges. The bridge mandrel depicted in FIGS. 9A, 9B, 9C and 9D below would be used when mounting plates sleeves using methods 1) and 2). The bridge mandrel depicted in FIGS. 10A, 10B, 10C and 10D would be used when mounting plates sleeves using methods 3).

FIGS. 9A, 9B, 9C and 9D show various views of a repeat builder for use as a bridge mandrel with a thru-hole design. FIG. 9A shows a cross section taken at section line 9A-9A, shown on FIG. 9C, of a bridge mandrel exhibiting the inner sleeve 11, compressible foam layer 16, thin layer of hard foam 17, and end cap 25. It is at this point that the repeat builder is modified for use as a bridge mandrel. Thru-holes 33 and 34 are drilled radially through the unit at end cap 25. The specific number of thru-holes can be as few as one and as many as eight. The quantity will depend upon the diameter of the bridge mandrel to ensure adequate air supply to the circumference during mounting and demounting plate sleeves. In addition to the thru-holes, an air channel 35 is added to facilitate air distribution similar to the manner achieved for mounting the outer sleeve 26. This air channel, however, will be used to mount the plate sleeves that will be used in conjunction with the bridge mandrel during printing. Air channel 35 is further identified in FIG. 9C.

FIG. 9B shows the opposite end of the bridge mandrel exhibiting the registration pin 36, registration pin insert 20 and inlet hole 27. As before, the section lines 9C-9C and 9D-9D in FIGS. 9A and 9B depict where cross sections are taken to expose internal components in FIGS. 9C and 9D.

FIG. 9C shows a cross section of the bridge mandrel taken at the section line 9C-9C defined in FIGS. 9A and 9B. This figure exposes the components from the previous two drawings but also more clearly shows the air channel 35 that runs the full circumference of end cap 25 as well as the air channel 29 that runs the full circumference of end cap 24. This figure also shows the presence of a downstream hole 42 that allows air to be delivered from the inside of the bridge mandrel to the outer surface of the bridge. Up to four downstream holes may be added to aid in mounting and demounting plate sleeves. Addition of a small air channel approximately 1/16″ wide by 1/32″ deep located in line with each downstream hole, and machined into the outer diameter of the outer sleeve 26 can aid in more uniform distribution of the pressurized air around the bridge diameter.

It should be noted that FIGS. 9A, 9C and 9D show the end cap 25 extending to the full diameter of the bridge mandrel. Previous figures of the thick sleeve have shown the outer sleeve 26 covering both end caps. In fact, when a thick sleeve is converted to a bridge mandrel, thru-holes 33 and 34 would be drilled through the outer sleeve 26. However, when a repeat builder is specifically designed as a bridge mandrel, it is preferred to construct the end cap 25 so that it extends to the full diameter of the bridge and the outer sleeve 26 butts against the edge of the end cap 25.

FIG. 9D shows a cross section of the bridge mandrel taken at the lines 9D-9D defined in FIGS. 9A and 9B. This figure exposes the components from the previous three drawings but also the radial hole 28 that connects the inlet hole 27 to the air channel 29. The plug 32 is also shown threaded into inlet hole 27.

When a thru-hole design is used it is often necessary to match the location of the thru-holes on the bridge mandrel with pre-drilled holes on the mandrel to which the bridge mandrel is being mounted. The tolerances for matching the location of these holes can be relaxed if the thru-holes are slightly enlarged at their exit point on the inner diameter of the inner sleeve. This amounts to machining a shallow narrow disc up to ¼″ wide and up to 1/32″ deep on the inner sleeve at the exit point of each thru-hole. Another manner for achieving this is to machine a shallow, narrow groove on the inner diameter of the inner sleeve coincident with the thru-holes.

Some printing presses are not configured to mount plate sleeves onto bridges using air supplied through mandrels. Instead, the air is supplied from the press to a side port on the bridge or it may not be supplied from the press at all but rather from a separate air supply. In those instances, a thru-hole design is inadequate and air must be supplied at the end of the bridge mandrel and distributed through the bridge body. This can be accomplished by imbedding internal piping or tubing within the hard foam core of the bridge mandrel body and distributing it to various locations within the bride as required.

FIGS. 11A, 10B, 10C and 10D show various views of a repeat builder for use as a bridge mandrel with an internal air design. FIG. 10A shows a cross section taken at section lines 10A-10A, shown on FIG. 10C, of a bridge mandrel exhibiting the inner sleeve 11, compressible foam layer 16, thin layer of hard foam 17, end cap 25, and outer sleeve 26. In addition, an air distribution ring 37 is shown imbedded within end cap 25 and connected to internal piping 38. Internal piping 38 and distribution ring 37 provide the means for distributing pressured air through the bridge mandrel interior. Suitable material for internal piping 38 and distribution ring 37 include lightweight metallic tubing or plastic tubing. The material density, wall thickness and diameter should be selected so as to minimize adding weight to the unit which could result in an imbalance condition. Holes 39 and 40 are drilled radially through end cap 25 until they penetrate the distribution ring 37. Holes 39 and 40 allow the air to be delivered to the outer diameter of the bridge mandrel, thus enabling plate sleeves to be mounted or demounted to the bridge. Up to four holes may be drilled and connected to distribution ring 37.

FIG. 10B shows the opposite end of the bridge mandrel exhibiting the registration pin 36, insert 20 and the inlet hole 27. In addition, fill hole 41 is shown which provides a port or connection for pressurizing the air distribution system with in the bridge mandrel. Fill hole 41 can be simply the termination of the internal piping or it can have a variety of standard air fittings for attaching to an air source. The section lines 10C-10C and 10D-10D depict where cross sections are taken to expose internal components in FIGS. 10C and 10D.

FIG. 10C shows a cross section of the bridge mandrel taken at the lines 10C-10C defined on FIGS. 10A and 10B. This figure exposes the components from the previous two drawings but also more clearly shows the air channel 35 that runs the full circumference of end cap 25 as well as the air channel 29 that runs the full circumference of end cap 24. This figure also reveals the location of internal piping 38 as it travels down the length of the bridge mandrel and connects to the distribution ring 37. Finally, this figure shows the location of a downstream hole 43 that connects to the internal piping 38 and supplies additional pressurized air along the bridge mandrel length. Up to four downstream holes may be added to aid in mounting and demounting plate sleeves. As with the thru-hole design, addition of a small air channel approximately 1/16″ wide by 1/32″ deep, located in line with each downstream hole, and machined into the outer diameter of the outer sleeve 26 can aid in more uniform distribution of the pressurized air around the bridge diameter.

FIG. 10D shows a cross section of the bridge mandrel taken at the section line 10D-10D defined on FIGS. 10A and 10B. This figure exposes the components from the previous three drawings but also the radial hole 28 that connects the inlet hole 27 to the air channel 29. The plug 32 is also shown threaded into inlet hole 27.

What is claimed:

1. A repeat builder comprising an inner cylindrical sleeve for mounting around a cylinder or mandrel, an adhesive layer surrounding said inner sleeve, a compressible foam layer surrounding said adhesive layer, a non-compressible hard foam core surrounding said compressible layer, solid end caps sealing the ends of the repeat builder, and a cylindrical outer sleeve held in place via an interference fit between the hard foam core and end caps thus allowing said outer sleeve to be removed and replaced with a new outer sleeve when required.

2. The repeat builder of claim 1 wherein a cavity is formed within said hard foam core for the purpose of filling with polymeric material to form said end caps.

3. The repeat builder of claim 1 wherein said end caps are metallic and secured to said hard foam core using adhesives.

4. The repeat builder of claim 1 wherein an insert is mechanically and adhesively encapsulated within at least one of said end caps for the purpose of positioning said repeat builder on the mandrel through the alignment of a notch located on said insert with a registration pin located on the mandrel.

5. The repeat builder of claim 4 wherein said insert has surfaces available in all three planar directions to resist radial, longitudinal and axial loads when in contact with the registration pin on the mandrel.

6. The repeat builder of claim 1 wherein said outer sleeve is mounted over said hard foam core by expanding said outer sleeve using pressurized air supplied through holes and channels machined into at least one of said end caps.

7. The repeat builder of claim 1 wherein said outer sleeve is replaceable by expanding said outer sleeve using pressurized air supplied through holes and channels machined into at least one of said end caps.

8. The repeat builder of claim 1 wherein thru-holes are drilled through the repeat builder wall to convert said repeat builder to a bridge mandrel, thus enabling the mounting of plate sleeves to the bridge mandrel.

9. The bridge mandrel of claim 8 wherein a shallow, narrow groove is machined around the circumference of the outer diameter of said outer sleeve, coincident with said thru-holes, to facilitate distribution of pressurized air when mounting plate sleeves.

10. The bridge mandrel of claim 8 wherein a shallow, narrow groove is machined around the circumference of the inner diameter of said inner sleeve, coincident with said thru-holes, to facilitate transfer of pressurized air from holes on said mandrel to thru-holes on said bridge mandrel.

11. The bridge mandrel of claim 8 wherein a shallow, narrow disc is machined on the inner diameter of said inner sleeve, coincident with each of said thru-holes, to facilitate distribution of pressurized air to each said thru-holes.

12. The bridge mandrel of claim 8 wherein bridge mandrel includes a notch of a straight configuration for positioning said bridge mandrel on the registration pin located on the mandrel.

13. The bridge mandrel of claim 8 wherein said bridge mandrel includes a notch of a bayonet configuration for positioning said bridge mandrel on the registration pin located on the mandrel and locking said bridge mandrel onto the mandrel by rotating said bridge mandrel onto the registration pin.

14. The repeat builder of claim 1 wherein said end caps and said hard foam core have internal tubing or piping to distribute pressurized air to various locations on the repeat builder diameter to convert said repeat builder to a bridge mandrel, thus enabling the mounting of plate sleeves to the bridge mandrel.

15. The bridge mandrel of claim 14 wherein connecting holes are drilled through the repeat builder wall to connect to said internal tubing or piping to transfer pressurized air to the outer diameter of said outer sleeve.

16. The bridge mandrel of claim 14 wherein a shallow, narrow groove is machined around the circumference of the outer diameter of said outer sleeve, coincident with said connecting holes, to facilitate distribution of pressurized air when mounting plate sleeves.

17. The bridge mandrel of claim 14 wherein said bridge mandrel includes a notch of a straight configuration for positioning said bridge mandrel on the registration pin located on the mandrel.

18. The bridge mandrel of claim 14 wherein said bridge mandrel includes a notch of a bayonet configuration for positioning said bridge mandrel on the registration pin located on said mandrel and locking said bridge mandrel onto the mandrel by rotating said bridge mandrel onto the registration pin.

19. A method of making and using a repeat builder comprising providing an inner sleeve, adhesively mounting a compressible foam layer around the inner sleeve, mounting a non-compressible hard foam core around the compressible foam layer to form an assembly, sealing the ends of the assembly with solid end caps to form a repeat builder, mounting an outer sleeve around the repeat builder, mounting the repeat builder to a cylinder or mandrel by locating the inner sleeve around the cylinder or mandrel, and holding the outer sleeve in place by an interference fit between the hard foam core and the end caps to selectively permit the outer sleeve to be removed and replaced with a new outer sleeve.

20. The method of claim 19 wherein the repeat builder is positioned on a mandrel through use of an insert encapsulated within at least one of the end caps with the insert having a notch, and aligning the notch with a registration pin on the mandrel.

21. The method of claim 19 wherein thru-holes are drilled through the repeat builder wall to convert the repeat builder to a bridge mandrel, and mounting plate sleeves to the bridge mandrel.

22. The method of claim 19 wherein pressurized air is distributed to various locations on the repeat builder diameter through internal tubing/piping in the end caps and hard foam core to convert the repeat builder to a bridge mandrel, and mounting plate sleeves to the bridge mandrel.
